(19) United States
(12) Patent Application Publication
(10) Pub. No.: US 2025/0358175 A1
(43) Pub. Date: Nov. 20, 2025

(54) FAST AND SCALABLE CONNECTOR FOR NETWORK CONNECTIVITY

(71) Applicant: Calix, Inc., San Jose, CA (US)

(72) Inventors: Jinhong Wang, Nanjing Jiangsu (CN); Xiaobing Yu, Nanjing Jiangsu (CN); Panke Shi, Nanjing Jiangsu (CN)

(21) Appl. No.: 18/670,647

(22) Filed: May 21, 2024

(30) Foreign Application Priority Data
May 14, 2024 (CN) 2024105985501

(51) Int. Cl. H04L 41/0663; H04L 47/56; H04L 47/6275

(52) U.S. Cl. CPC H04L 41/0663; H04L 47/56; H04L 47/6275

(57) ABSTRACT

A fast, scalable network connector that reliably and instantly creates link connections between management control plane and network device data plane nodes. A central database persists node states and provides a global connectivity view for system recovery. A master scheduler selects, prioritizes, and dispatches re-connect tasks. A multi-layer, elastic worker scheduler concurrently performs actual connection tasks through a socket I/O layer to the network nodes. The worker scheduler is scaled up or down as needed by the master scheduler. A feedback learner gathers information about node states and connectivity to provide insights that inform the scaling of the worker scheduler and scheduling of the re-connect tasks.

### TECHNICAL FIELD

Embodiments relate to the field of large-scale networks, and more particularly, to a system for fast and efficient connection of network nodes.

### BACKGROUND

In large-scale computer deployments, within any short time period, there are potentially many running network nodes (devices or servers) that go down and come up later due to various different reasons, such as software or firewall upgrades, security patches, scheduled maintenance, power outages, and so on. In the situation, a local client node (such as SMx network control plane) needs to be able to actively connect to the nodes that cycle down and up the first time in the most efficient and quickest way possible for any subsequent service and operation.

One present approach to handle this situation is to use a single thread to execute reconnection tasks of down-up remote nodes sequentially. This solution is simple and easily implemented, but has serious performance and scalability drawbacks due to bottleneck issues, especially under large-scale reconnection demands. Another present approach is to employ multiple threads independently and repeatedly execute mass reconnect tasks in parallel. This can provide good performance with pure parallelization, but generally lacks advanced features and other considerations (i.e., resource overruns, connection-spike and coordination). Similarly, a timing-wheel algorithm to interleave reconnecting nodes, represents a pure data algorithm that may be suitable as an underlying implementation, but does not provide a complete product solution. In general, these prior existing methods do not provide an appropriate end-to-end approach to meet the product-ready demands of large-scale, high availability, cluster system deployments.

What is needed, therefore, is a fast and scalable connector for network connectivity that minimizes communication disruptions to provide guaranteed continuous availability of service and management for thousands of remote reconnecting nodes that need a client-peer system to reconnect actively in real-time.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be invention embodiments. AXOS and AXOS DPx are trademarks of Calix, Inc.

### BRIEF DESCRIPTION OF DRAWINGS

In the following drawings like reference numerals designate like structural elements. Although the figures depict various examples, the one or more embodiments and implementations described herein are not limited to the examples depicted in the figures.

FIG. 1 illustrates a system implementing a fast, scalable connector, under some embodiments.

FIG. 2 illustrates the fast, scalable connector of FIG. 1 in greater detail, under some embodiments.

FIG. 3 is a block diagram illustrating components and signal flows for a fast, scalable connector, under some embodiments.

FIG. 4 illustrates a set of long-lived not-connected (LLnC) devices, under some embodiments.

FIG. 5 is a flow diagram illustrating an overall sequence of workflows among components in a fast, scalable connector, under some embodiments.

FIG. 6 is a flow diagram illustrating an sequence of workflows among components in a fast, scalable connector for spike and scale handling, under some embodiments.

FIG. 7 is a flow diagram illustrating an sequence of workflows among components in a fast, scalable connector for abnormal LLnC node handling, under some embodiments.

FIG. 8 is a flow diagram illustrating an overall process of sending reconnection requests for massively disconnected nodes using a fast, scalable connector, under some embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are neither constrained to a particular order or sequence, nor constrained to a particular system configuration. Additionally, some of the described embodiments or elements thereof can be combined, occur, or be performed simultaneously, at the same point in time, or concurrently.

It should be noted that the described embodiments can be implemented in numerous ways, including as a process, an apparatus, a system, a device, a method, or a computer-readable medium containing computer-readable instructions or computer program code, or as a computer program product having computer-readable program code embodied therein. In the context of this disclosure, a computer-usable medium or computer-readable medium may be any physical medium that can contain or store the program for use by or in connection with the instruction execution system, apparatus or device.

Reference will now be made in detail to the disclosed embodiments, examples of which are illustrated in the accompanying drawings. Unless explicitly stated, sending and receiving as used herein are understood to have broad meanings, including sending or receiving in response to a specific request or without such a specific request. These terms thus cover both active forms, and passive forms, of sending and receiving.

Embodiments are directed to a network management system (NMS) connector that is both fast in that it is able to quickly establish a connection or reconnection as soon as a certain remote node is ready, and scalable in that is able to scale linearly to meet connection demands in the event of massive number of nodes simultaneously going down and then back up.

In general, a connector is a software component that instantly and reliably creates and manages link connections between management control plane and network device data plane nodes. An example connector is the AXOS DPx connector from Calix, Inc., that enables cable operators to deploy software-defined network (SDN) capabilities in their access networks without disrupting their current back office environments. The software-based DPx connector acts as a translation layer between back office systems and a software-defined access operating system.

In an embodiment, the connector is designed and configured to provide fast network recovery after a mass disconnection event of large numbers of network nodes. A central database (DB) keeps and updates a record of the current connection status of all devices, and a control plane consisting of multiple pairs of master and worker schedulers efficiently connects disconnected devices. For each pair of master scheduler and worker scheduler, the master scheduler periodically filters out, based on predefined policy (e.g. local cluster membership) and/or feedback collected by a feedback learner, a list of disconnected devices and submits the list to worker scheduler. The worker scheduler comprises two layers and is responsible for performing network connection. The worker scheduler is elastic, such that if the scale of disconnected devices is very large, master scheduler is able to scale up the capacity of that worker scheduler, which allows worker scheduler to concurrently connect more devices. Once the task peak has passed, master scheduler can scale down worker scheduler's capacity to free up hardware resources.

The system also features a two-layer scheduler: L1 scheduler and L2 scheduler. The task submitted by master scheduler first goes to the L1 scheduler, and if overloaded, L1 scheduler loads part of the task with random delay to the L2 scheduler. The L2 scheduler also needs to handle with connection failures that have occurred, such that all the devices that failed to connect after a first try will be loaded to the L2 scheduler. In this way, devices such as long-lived, not-connected devices will be deprioritized so as not to consume the L1 scheduler's resources, which potentially gives priority to other devices and enables efficient and fast network recovery.

The feedback learner is able to collect, in real time, key performance indicators (KPIs) from the L1 and L2 schedulers and detect long-lived, not-connected devices. The master scheduler periodically acquires this information from the feedback learner and schedule tasks based on this component.

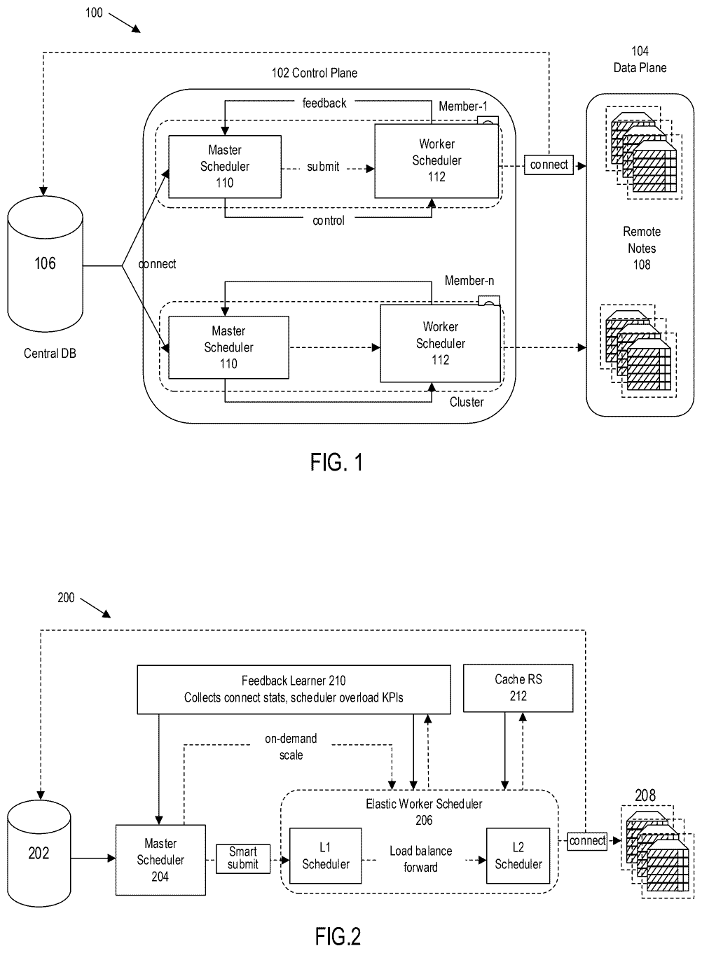

FIG. 1 illustrates a system implementing a fast, scalable connector at a high level, under some embodiments. As shown in FIG. 1, the connector system 100 consists of several components, including a data plane 104 having a plurality of remote nodes 108, and a control plane 102. System 100 also has a central database 106 that persists all managed network device data plane nodes 108, and provides a global connectivity state view for the cluster and system recovery.

The control plane 102 comprises a number of members, denoted Member 1 to Member n, as shown. Each member has a master scheduler 110 and a worker scheduler 112 set that connects to respective nodes in the data plane 104.

As shown in FIG. 1, and as described in greater detail below, system 100 includes a control and feedback loop between the master scheduler 110 and worker scheduler 112, as well as connect signals between the central database 106 and the master-worker schedulers and data plane 104. To provide guaranteed speed and scalability, system 100 includes a two-phase, dual scheduler. This scheduler design involves the master scheduler 110 globally managing and dispatching tasks, while the worker-scheduler 112 executes these tasks concurrently for the nodes 108.

FIG. 2 illustrates the fast, scalable connector of FIG. 1 in greater detail, under some embodiments. As shown in FIG. 2, system 200 includes central database 202 coupled to a master scheduler 204, which is a global connectivity coordinator that selects, prioritizes, and dispatches re-connect tasks periodically, and is responsible for monitoring, governance, and cluster awareness. The multi-layer worker scheduler 206, is an elastic connectivity worker that performs the actual connection tasks for all disconnected nodes concurrently (in parallel).

The central database 202 stores device information for all of the remote nodes 208, where the information contains the node which manages the device, the connection status, last connected time, last disconnected time, and so on. The remote nodes 208 generally represent one or more device nodes (and typically thousands) that are managed by a management system and accept connection requests from the system.

The master scheduler 204 is responsible for filtering and prioritizing connection requests based on the information provided by the database 202 and feedback learner 210. It is also responsible for submitting the requests to the worker scheduler 206, and scaling up/down the resources in worker scheduler. When reading the initial information from the database, master scheduler can take filter action based on the some fields of the device information, such as a manageable flag indicating if a device should be managed by a network manager, a pre-previsioning flag indicating the device is not yet to go online for management, and so on. A connection request submitted by the master scheduler carries all the required information to establish a connection with a managed device, including device name, device IP address, port, etc.

For the embodiment of FIG. 2, the layered and load balancing worker scheduler 206 comprises two layers (L1, L2) that execute locally with better isolation to distribute task traffic to next layer when overloaded to maximize throughput. The worker scheduler 206 design enables the connector to be implemented with a small resource footprint by using a bounded queue and fixed size of thread pool, and enables automatic, on-demand vertical scaling as the workload of connection tasks spike and shrink in a dynamic network comprising high numbers of remote nodes 208.

The layered worker scheduler 206 is responsible for processing the connection requests from the master scheduler 204. When a request comes in that is within its present processing capacity of the L1 scheduler, the worker scheduler 206 will process the request directly. If it cannot handle the request in L1, it will then submit the request to the L2 scheduler. The L2 scheduler uses a scalable queue and thread pool to run the requests in a scheduled way. i.e., each request will be scheduled for execution at a future time. The resource footprint can vary greatly based on the pending request count. The maximum size of a L2 scheduler thread pool is limited by certain factors such as the underlying OS type, OS release version, physical memory size, etc. The system is generally configured to keep the size of a thread pool within a reasonable range to avoid excessive resource consumption and potential performance issues.

System 200 implements socket-based, I/O-layer driven reactive re-scheduling to ensure faster reconnects to minimize service connectivity interruption. A connect socket I/O is reactively triggered to re-schedule connection attempts in accordance with configurable settings.

It should be noted that the terms ‘connection’ and ‘reconnection’ may be used interchangeably to refer to a valid functional coupling between components. In general, a ‘connection’ may imply a first time connection, while ‘reconnection’ may imply a subsequent connection after a first connection has been interrupted. Whether connected or reconnected, the two components are then considered to be connected or in connection.

System 200 also implements feedback and learning driven smart scheduling through a feedback learner component 210. This ensures the system can enforce the most suitable reconnect strategy by leveraging a learned history and statistics of past connections. Based on the load of the elastic worker scheduler 206, which is wither running tasks, queueing pending tasks, etc. the feedback learner 210 dynamically scales up and down the thread pool size of the L2 scheduler in worker scheduler 206. The feedback learner 210 generally collects the status of each worker scheduler, including processing and pending requests, working queue depth, the LLnC devices, etc., and then provides this information to the master scheduler 204.

The system further implements node-affinity based cluster scheduling. It uses a node affinity-based, cluster-aware approach to simplify cluster management and scheduling autonomously for large-scale production deployments.

The database 202 implements a table-based fault tolerant recovery scheme to ensure that the connector can continue to operate in spite of a failure (i.e., restart, upgrade, unexpected crash, power outage) for a high availability and failure recovery system.

System 200 also includes a cache 212 holding a cache remember set (RS) that contains holds all the devices 208 that are in a connecting or pending connection state in order to avoid duplicated connection requests from the same device.

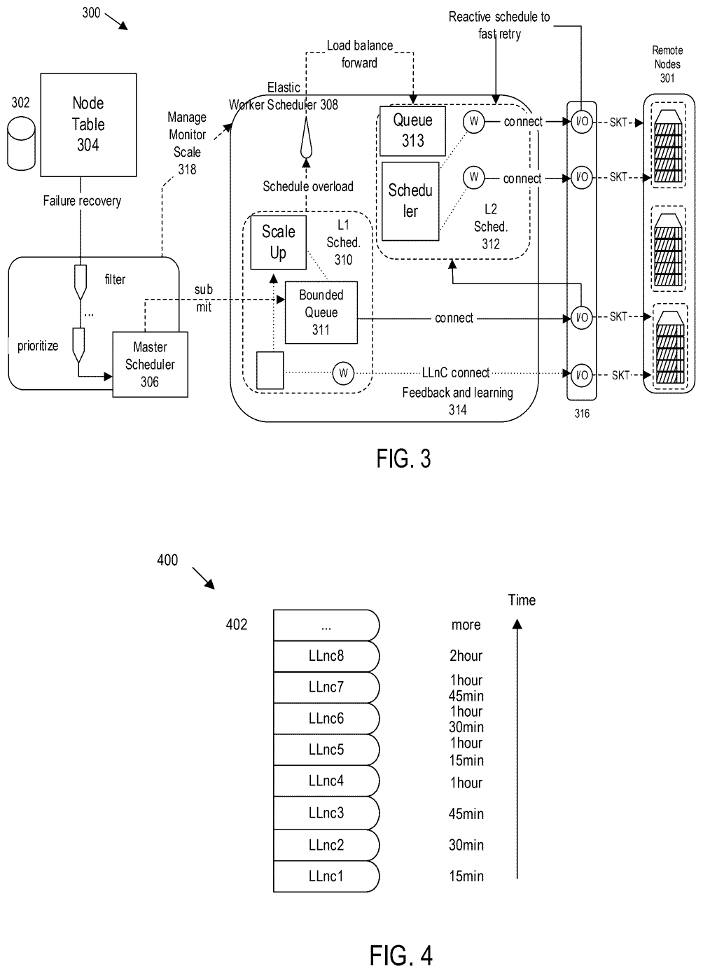

FIG. 3 is a block diagram illustrating components and signal flows for a fast, scalable connector, under some embodiments. For the embodiment of system 300, database 302 holds a node table 304, which is a tabular data element that holds relevant information for the devices of the remote nodes 301. A node table is generally meant to refer to a data element (table, list, database, text document, etc.) that provides a global view for all device connection states and cluster management. It is also persists provider data for failure recovery purposes

In an embodiment, the remote nodes 301 (which may be clients and/or servers) each contain one or more devices that are in a state of connection or non-connection with the system and one another. The states can include: connected, not connected (disconnected or non-connected), pending connection, or failing (pending disconnection). A non-connected device that was not intended to be disconnected is a device that is intended to be re-connected as quickly as possible by the fast, scalable connector 300 to maintain overall network function. Such a re-connected device will then re-establish a connected state.

In an embodiment, the relevant devices in remote nodes 301 that may suffer periodic failure or disconnection are established and deployed devices that are not temporary or transient in nature. Such devices are referred to long-lived devices, and when unintentionally disconnected are referred to as long-lived not connected (LLnC) devices. An LLnC design generally allows for prioritized/ranking connection scheduling and minimizes LLnC device interference.

LLnC devices may be of various ranks depending on device type, device criticality, failure time or disconnect duration, and so on. FIG. 4 illustrates a set of long-lived not-connected (LLnC) devices, under some embodiments. Diagram 400 shows a set of LLnC's along a time line ranging from several minutes to several hours or more (e.g., days, weeks, etc.), and any appropriate time-scale may be used. Each LLnC of the example set 402 is ranked along a scale, such as from 1 to 8 along a time axis where the level of LLnC depends on a random amount of delay per device that is used by the L2 scheduler to prioritize re-connecting devices, such as from 15 minutes for LLnC_1 to 2 hours for LLnC_8, and so on. In an embodiment, the level of LLnC device dictates its priority with respect to re-connection with LLnC_1>LLnC_2>LLnC_3> . . . >LLnC_8, for the example shown.

The LLnC value basically dictates a delay imposed to reconnect a device that results in the device being unavailable for this additional amount of time. That is, an LLnC value basically represents scheduling priority based on a scheduled delay time in specific implementations.

FIG. 4 is provided for purposes of example only, and any number of LLnC devices may be listed and ranked, and the time-scale may be set to any appropriate range.

With reference back to FIG. 3, and as described above, the connector 300 comprises a two-phase-based, dual scheduler, where a first phase is executed by a master-scheduler that prioritizes, dispatches tasks, and manages scheduling globally in the network, and a second phase is executed by a worker scheduler locally executing reconnections, re-scheduling the tasks on-demand when necessary, and collecting data for analysis and feedback.

As shown in system 300, the node table 304 stores the connection or disconnection status of each device of the nodes 301, and provides a failure recovery plan for the connector 300. The node table provides a DB-based fault tolerant recovery scheme. The connector 300 saves the remote nodes to the node table 304 as global and persistent states. The system can thus continue to perform reconnect scheduling even though the application may have restarted after a failure or interruption (e.g., upgrade, software defect, etc.).

This failure recovery information is filtered and prioritized by the master scheduler 306. In a first phase (Phase-I) of scheduling, the master scheduler 306 prioritizes and dispatches tasks for submission (through ‘submit’ command) to the worker scheduler 308. The master scheduler 306 also performs a management function 318 that monitors and scales the tasks dispatched to the worker scheduler 308. It does this globally for all of the disconnected devices of nodes 301, and the tasks dispatched ultimately cause reconnection or connection retry operations (‘connect’) from I/O layer 316 to the nodes 301 through socket I/O commands.

For the second phase (Phase-II), the scheduled and submitted tasks from master scheduler 306 are then input to the worker scheduler 308, which contains independent L1 and L2 (overflow) schedulers. The worker scheduler thus comprises a multi-layer scheduler that acts as a single executor-service that trades off isolation (reduced interference) and load balancing.

The L1 scheduler 310 contains a bounded queue 311. It uses a thread pool of fixed size to process connection requests in real time. However, its capacity is limited by the queue size so that when it is overloaded, further requests are sent to L2 scheduler 312. To maintain independence, the L1 and L2 schedulers each have their own queues and thread pools that are not sharable.

The master scheduler 306 initially submits reconnect tasks to L1 scheduler 310, which will be passed directly to the nodes through I/O layer 316 if accommodated by the L1 scheduler. However, if L1 overloads, it will further forward tasks to the L2 scheduler 312 adaptively with a random delay. This delay is set by the LLnC level of the re-trying devices and is used for load-balancing purposes so that the L2 scheduler is not overwhelmed by simultaneously timed reconnection tasks coming from the L1 scheduler.

The worker scheduler contains an unbounded queue 313, but prioritizes (or drops) connection requests based on the defined LLnC level. For devices of LLnC 8 or higher, there are chances for L2 worker scheduler to simply drop the connection request to give resources to requests of higher connection priority. Appropriate rules can be defined to dictate the reconnection priority within the L2 scheduler. For example, it may be configured to only re-schedule fast retries for LLnC 1 level devices in order to add an extra reconnection chance to these devices beyond the main connection cycle. Other similar rules may also be defined depending on system configuration and requirements.

The originally scheduled (from L1) or reactively rescheduled (from L2) connection tasks are then sent as ‘connect’ commands from the worker scheduler 308 through a socket I/O layer 316 to the remote nodes 301. This socket I/O layer-driven reactive re-scheduling provides better fast-connections, and the socket I/O (SKT) will perform reactive re-schedule reconnect task to worker-scheduler. In general, a connect command can be a generic system command that forces or creates a connection between two components.

As shown in FIG. 3, a feedback and learning circuit 314 provides smart scheduling based on certain collected data. The connector collects, labels and monitors the performance of the system (e.g., active.threads, queued.tasks, etc.) and tasks (e.g., total.reconnects, schedule.delay, etc.) that may be provided in the form of statistics, historical data, trend data, expert knowledge bases, and so on, to apply the most suitable and efficient reconnect strategy for a set of disconnection circumstances.

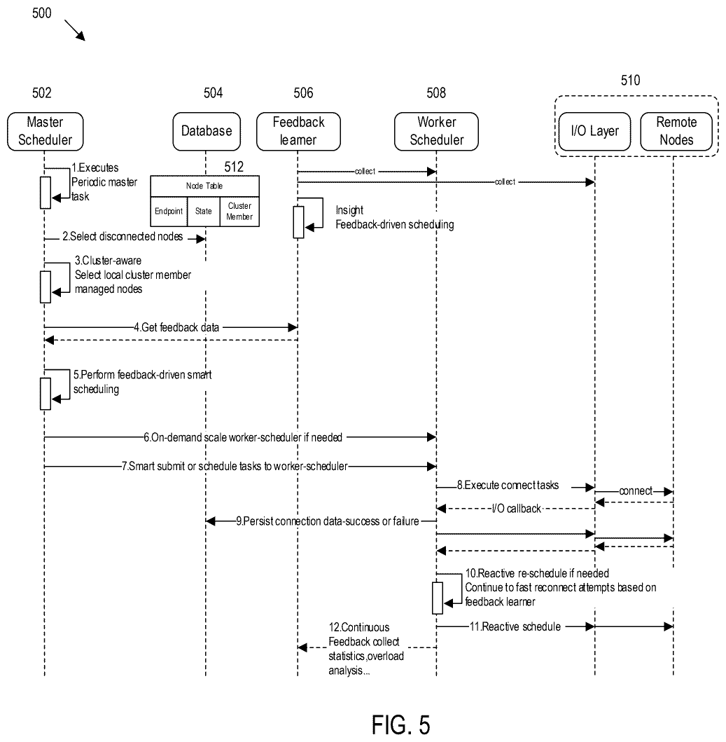

FIG. 5 is a flow diagram illustrating an overall sequence of workflows among components in a fast, scalable connector, under some embodiments. As shown in FIG. 5, diagram 500 shows process flows between a master scheduler 502, a database 504, a feedback learner 506, a worker scheduler 508, and an output stage 510 comprising an I/O layer and the remote nodes.

The database 504 provides a node table 512 that specifies an endpoint, state, and cluster member for each of the devices of the remote nodes. The master scheduler 502 executes a periodic master task process (step 1) and accesses the node table 512 to identify and select any disconnected nodes (step 2). The master scheduler 502 selects local cluster member managed nodes (step 3) to provide device reconnection through node-affinity based cluster scheduling. For this, the master-scheduler is able to achieve cluster-aware deployment and perform the cluster-per-node affinity scheduling to reconnect the corresponding disconnected remote nodes autonomously.

The feedback learner component 506 collects data and information from the worker scheduler 508 and I/O layer, remote nodes 510 to derive insights that produce feedback-driven smart scheduling. This is then used by the master scheduler 502 to schedule the reconnection tasks (step 5). The master scheduler scales, on-demand, the worker scheduler if necessary (step 6) and submits the scheduled tasks to the worker scheduler 508 (step 7).

The worker scheduler then executes the connection tasks by sending ‘connect’ commands to the remote nodes through the I/O layer. The output stage 510 sends back an I/O callback to indicate connection success or failure back to the database 504 (step 9). The worker scheduler performs a reactive re-schedule of the reconnection task if necessary, such as if the previous connection attempt failed (step 10). This reactive re-scheduling is performed as often as needed based on a reactive schedule (step 11). Throughout the scheduling and rescheduling of reconnection requests, the worker scheduler 508 continues to collect and provide relevant data for input back to the feedback learner 506 (step 12). In this manner, the connector applies, in a fine-grained way, a reactive re-scheduling process based on analysis of multiple information points, such as exceptions filter, retry throttle, random delay, LLnC-matches, and so on.

As shown in the process flow of FIG. 5, the connector utilizes a resource efficient and elastic worker scheduler that starts upon the detection of hardware resource conditions during the system startup. For elastic capacity based on the runtime measurements, the connector is able to scale vertically when reconnection tasks spike and shrink.

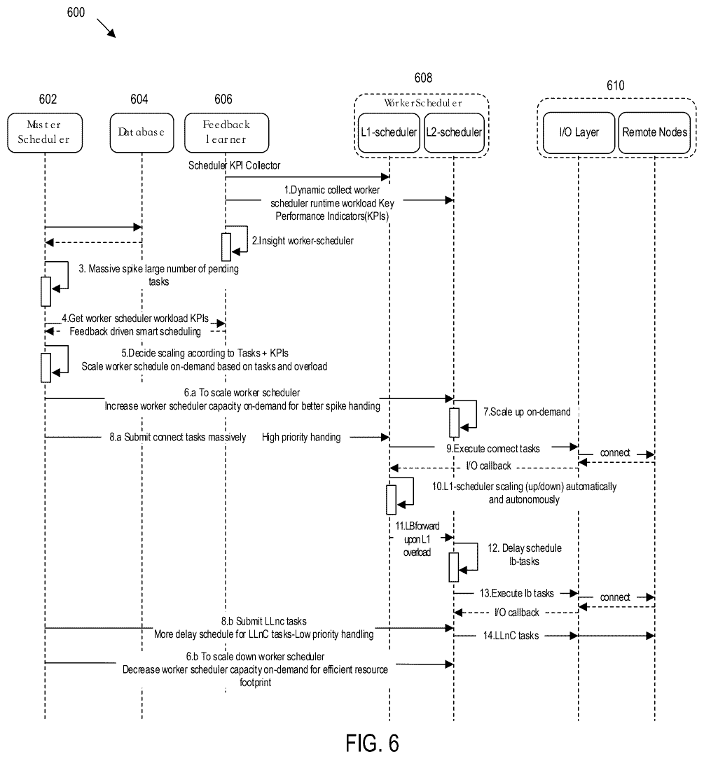

FIG. 6 is a flow diagram illustrating an sequence of workflows among components in a fast, scalable connector for spike and scale handling, under some embodiments. As shown in FIG. 6, diagram 600 shows process flows between a master scheduler 602, a database 604, a feedback learner 606, a worker scheduler 608 comprising L1 and L2 schedulers, and an output stage 610 comprising an I/O layer and the remote nodes.

For this embodiment, the feedback learner 606 functions as a collector of key performance indicators (KPIs) to dynamically collect runtime workload data from the worker scheduler 608, both the L1 and L2 schedulers (step 1). In an embodiment, KPIs can be timer tasks, or I/O-event driven, and can include scheduler workload statistics, LLnC group details, worker thread count, queue depth, and so on.

The feedback learner then derives insights about the worker scheduler (step 2). Insights can comprise any relevant information regarding device states and loads. In an embodiment, this information can be provided by an operating system (OS) function or location, such as “/Sys/WorkerScheduler/Socket/Device/” or similar resource.

For the embodiment of FIG. 6, it is assumed a massive spike event (step 3) is reported to and stored in the database 604. This can be due to a number of nodes becoming unintentionally disconnected at the same or near simultaneous time, thus resulting in a large number of pending tasks (reconnections) needing to be scheduled. In response, the master scheduler 602 then gets the worker scheduler workload KPI data from the feedback learner 606 to achieve feedback-driven smart scheduling (step 4).

The master scheduler 602 then decides a scaling of the worker scheduler based on the tasks and KPI data in order to scale the worker scheduler 608 based on the real-time demand of tasks and actual and potential scheduling overloads (step 5). Scaling the worker scheduler increases the worker scheduler capacity on-demand for better spike handling (step 6.a). The L2 scheduler of worker scheduler 608 then scales up as required (step 7). In an embodiment, scaling is performed vertically by adding more virtual or OS threads within a single machine and/or horizontally by adding more machines to the cluster. Other scaling schemes can also be used, as appropriate.

After the worker scheduler is adequately scaled, the master scheduler 602 then submits the connection tasks in parallel to the worker scheduler 608 (step 8.a). The worker scheduler then executes the connection tasks through the I/O layer and remote nodes in output stage 610 (step 9). The output stage sends an I/O callback to the worker scheduler, and the L1 scheduler then scales up or down automatically and autonomously (step 10). It should be noted that the L1 scheduler scales autonomously, while the L2 scheduler is scaled by the master scheduler.

In the event that the L1 scheduler in 608 is overloaded, the overflow reconnection tasks are forwarded to the L2 scheduler (step 11). The L2 scheduler applies the appropriate delay based on the LLnC level of the devices, as shown in FIG. 6, (step 12). These tasks are then executed at the appropriate time by the output stage 610 (step 13), which then sends an I/O callback to the L2 scheduler.

As shown in FIG. 6, the LLnC level information is also used by the master scheduler 602 to submit connection tasks directly to the L2 scheduler for low priority handling (step 8.a), and the L2 scheduler can then send connection requests to the I/O layer accordingly (step 14).

As mentioned above, the worker scheduler 608 can be scaled up in the event of high connection requests or scaled down in the event of little or no requests, to save system resources. To scale down the worker scheduler, the master scheduler 602 decreases the worker scheduler capacity for efficient resource use (step 6.b). This decrease can be performed by reclaiming resources through a decrease in virtual or OS threads in a worker scheduler process, or similar.

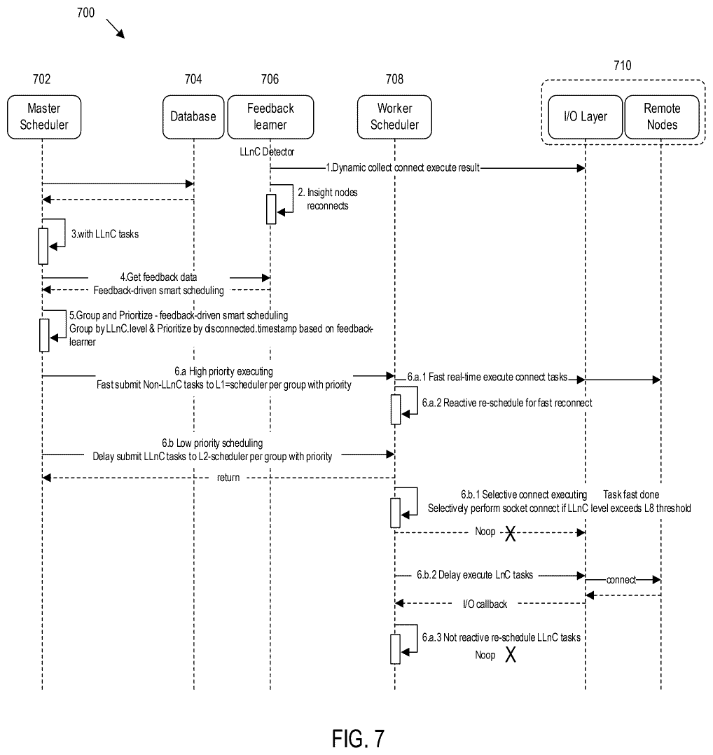

In some instances, certain devices or nodes may encounter abnormal operation. FIG. 7 is a flow diagram illustrating an sequence of workflows among components in a fast, scalable connector for abnormal LLnC node handling, under some embodiments. As shown in FIG. 7, diagram 700 shows process flows between a master scheduler 702, a database 704, a feedback learner 706, a worker scheduler 708 comprising L1 and L2 schedulers, and an output stage 710 comprising an I/O layer and the remote nodes.

For this embodiment, the feedback learner 706 dynamically collects connection execution results from the I/O layer of 710. The feedback learner then generates insights about the node reconnection operations (step 2).

The master scheduler 702 sends connection requests per the LLnC levels (step 3). The master scheduler 702 gets feedback data from the feedback learner 706 for the feedback-driven smart scheduling (step 4), and prioritizes the connection requests by LLnC level, as prioritized by the disconnected timestamp based on the feedback learner (step 5).

In an embodiment, the LLnC level is scheduling priority with multiple-range randomness for smoothing traffic spikes, and delay time is implementation scheduling.

For high priority scheduling, the master scheduler 702 immediately submits non-LLnC tasks to the L1 scheduler per group with priority (step 6.a), and these are sent through the worker scheduler 708 as connect tasks to the I/O layer and remote nodes 710 (step 6.a.1). The worker scheduler sends a reactive re-schedule for fast reconnections (step 6.a.2).

For low priority scheduling, the master scheduler 702 submits delayed LLnC tasks to the L2 scheduler per group with priority (step 6.b), and these are sent through the worker scheduler 708 as selective connection tasks to the I/O layer and remote nodes 710 (step 6.b.1). The worker scheduler selectively performs socket connections if the LLnC exceeds a certain threshold (e.g., LLnC_8), and delays execution of the LLnC tasks (step 6.b.2). After connection and I/O callback from the I/O layer, the worker scheduler then performs a not reactive re-schedule of the LLnC tasks (step 6.a.3).

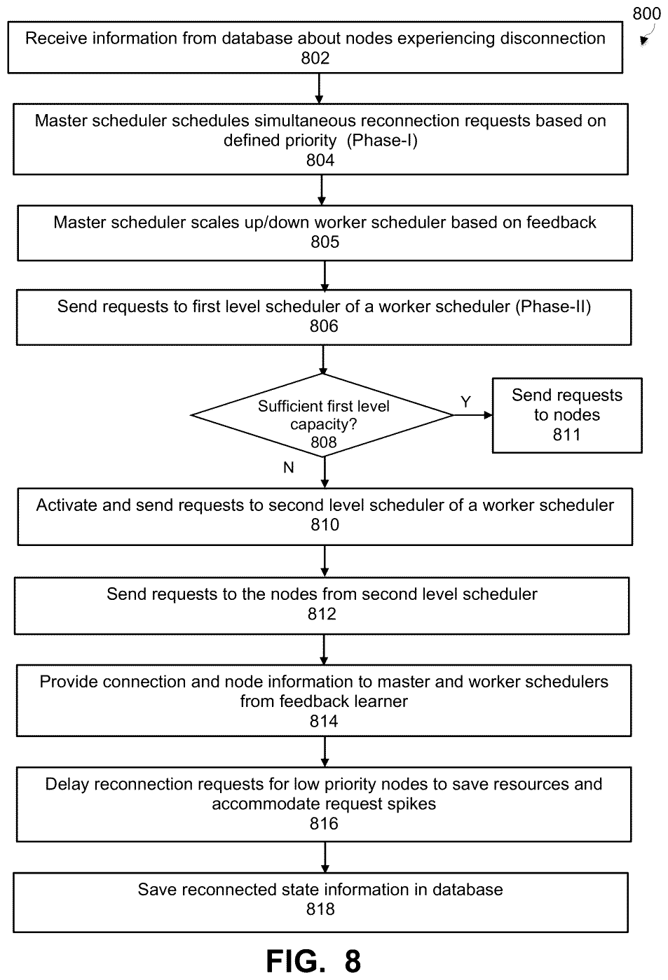

FIG. 8 is a flow diagram illustrating an overall process of sending reconnection requests for massively disconnected nodes using a fast, scalable connector, under some embodiments. The process 800 of FIG. 8 starts with the system database receiving information about nodes experiencing unintended disconnection, and typically on a massive scale, e.g., upwards of tens to hundreds of thousand nodes, 802.

In a first phase, the master scheduler schedules in parallel, reconnection requests that may factor in a LLnC priority of the devices, 804. The master scheduler works through a worker scheduler that it can scale up or down depending on event needs and system configuration, 805. After scaling, the master scheduler sends the reconnection requests to a first level (L1) scheduler of the worker scheduler, 806. The L1 scheduler has a bounded queue, so if the L1 scheduler is able to handle the requests on its own, as determined in decision step 808, it sends the requests to the nodes, such as by using an I/O sockets layer, 811. If, however, the L1 scheduler is overloaded, a second level (L2) scheduler with an unbounded queue is then activated, 810, and the requests are then sent to the nodes, 812, or dropped, if necessary.

Throughout the process 800, a feedback learner gathers and sends connection, re-connection, and node status information to the master and worker schedulers, 814. The feedback learner provides insights that are used to affect the scaling 805 and scheduling 804 steps.

In an embodiment, certain low or high priority levels can be set to dictate or modify the scheduling by the master and/or worker schedulers, 816.

After the reconnection tasks are accomplished the updated system and node states are sent to the database, 818.

The connector described herein offers a fast and scalable network connectivity to reliably and instantly to connect with resource efficient and elastic capacity. It also supports cluster deployment, fault-tolerant crash recovery, and learning-driven autonomous management. When the hundreds or thousands of remote nodes down-up occur massively in a short period of time, embodiments provide connection resilience with minimal interruption to the service which guarantees the real-time network connectivity in the standalone and cluster application deployment with the different deployment sizes.

As stated above, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media. In this manner, computer-readable media generally may correspond to tangible computer-readable storage media which is non-transitory. Data storage media may be any available media that can be accessed by one or more computers or one or more processors to retrieve instructions, code and/or data structures for implementation of the techniques described herein. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood that computer-readable storage media and data storage media do not include carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the term “processor” or “controller” as used herein may refer to any of the foregoing structures or any other structure suitable for implementation of the techniques described herein. Also, the techniques could be fully implemented in one or more circuits or logic elements.

The techniques of this disclosure may be implemented in a wide variety of devices or apparatuses, including an IC or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of reconnecting devices to a network after unintended disconnection, comprising:
receiving, in a database, information about nodes experiencing the unintended disconnection;
scheduling, concurrently in a master scheduler, reconnection requests to be transmitted to the nodes;
sending the requests to a first layer scheduler of a worker scheduler;
sending the requests from the first layer scheduler to the nodes if the first layer scheduler has sufficient resource capacity to process the requests; and
sending excess requests to the nodes through a second layer scheduler of the worker scheduler if the first layer scheduler does not have the sufficient resource capacity.

2. The method of claim 1 wherein the disconnection comprises a massive system interruption involving on the order of thousands of nodes.

3. The method of claim 1 wherein the first layer scheduler comprises a bounded queue storing the requests, and the second layer scheduler comprises an unbounded queue processing the excess requests.

4. The method of claim 1 further comprising sending the reconnection requests to the nodes using a socket-based input/output (I/O) layer.

5. The method of claim 1 further comprising defining a low or high priority level to each node of the nodes, wherein a priority level dictates a priority of a reconnection request schedule for a respective node.

6. The method of claim 5 further comprising designating a low priority level node to be a long lived not connected (LLnC) node.

7. The method of claim 6 further comprising assigning a random time delay to an LLnC node to delay a time of the reconnection request schedule for the LLnC node, and wherein the random time delay is selected from a range of possible time delay values on the order of several minutes to several hours.

8. The method of claim 1 further comprising updating the database with reconnection information after the reconnection requests are executed by the nodes.

9. The method of claim 1 wherein the master scheduler and worker scheduler are maintained in a control plane coupled to the database, and the nodes are maintained in a data plane coupled to the control plane.

10. The method of claim 1 further comprising:
scaling the worker scheduler to accommodate the reconnection requests based on system configuration, request volume, and feedback information; and
gathering node and connection information in a feedback learner to provide the feedback information.

11. A system for reconnecting devices to a network after unintended disconnection, comprising:
a database receiving information about nodes experiencing the unintended disconnection;
a master scheduler concurrently scheduling reconnection requests to be transmitted to the nodes; and
a worker scheduler having a first layer scheduler receiving the requests from the master scheduler, wherein the first layer scheduler sends the requests to the nodes if the first layer scheduler has sufficient resource capacity to process the requests, otherwise it sends excess requests to a second layer scheduler for transmission to the nodes.

12. The system of claim 11 wherein the master scheduler is scaled to accommodate the reconnection requests based on system configuration, request volume, and feedback information.

13. The system of claim 12 further comprising a feedback learner gathering node and connection information to provide the feedback information.

14. The system of claim 11 wherein the first layer scheduler comprises a bounded queue storing the requests, and the second layer scheduler comprises an unbounded queue processing the excess requests.

15. The system of claim 14 further comprising a socket-based I/O layer transmitting the reconnection requests to the nodes.

16. The system of claim 11 wherein the nodes are defined to be of low or high priority level, and further wherein a priority level dictates a priority of a reconnection request schedule for a respective node, and wherein a low priority level node is designated to be a long lived not connected (LLnC) node, and further wherein an LLnC node is assigned a random time delay to delay a time of the reconnection request schedule for the LLnC node.

17. The system of claim 11 wherein the master scheduler and worker scheduler are maintained in a control plane coupled to the database, and the nodes are maintained in a data plane coupled to the control plane.

18. A system for reconnecting devices to a network after unintended disconnection, comprising:
a central database receiving and storing information about state and connectivity of nodes experiencing the unintended disconnection;
a data plane containing the nodes; and
a control plane maintaining a master scheduler and a multi-layer scalable worker scheduler, wherein the master scheduler, in a first reconnect phase, prioritizes and dispatches reconnection requests to the data plane, and the worker scheduler, in a second reconnect phase locally executes re-connect tasks and collects statistics and data from a feedback learner to modify scaling of the worker scheduler and prioritization of the reconnection requests.

19. The system of claim 18 wherein the worker scheduler is scaled by the master scheduler to accommodate the reconnection requests based on system configuration, request volume, and the statistics and data from the feedback learner.

20. The system of claim 19 wherein the worker scheduler comprises a first layer scheduler receiving the requests from the master scheduler, wherein the first layer scheduler sends the requests to the nodes if the first layer scheduler has sufficient resource capacity to process the requests, otherwise it sends excess requests to a second layer scheduler for transmission to the nodes.
